(19) United States
(12) Patent Application Publication
(10) Pub. No.: US 2025/0335035 A1
(43) Pub. Date: Oct. 30, 2025

(54) INPUT PANELS FOR PIEZOELECTRIC FORCE SENSING AND HAPTIC FEEDBACK

(71) Applicant: Cambridge Touch Technologies Ltd., Cambridge, Cambridgeshire (GB)

(72) Inventors: Antony DUDLEY, Cambridge, Cambridgeshire (GB); Constantinos TSANGARIDES, Cambridge, Cambridgeshire (GB); Michael ASTLEY, Cambridge, Cambridgeshire (GB)

(21) Appl. No.: 18/866,095

(22) PCT Filed: May 16, 2023
(86) PCT No.: PCT/GB2023/051279

§ 371 Date: Nov. 15, 2024

(30) Foreign Application Priority Data
May 16, 2022 (GB) 2207148.4

(51) Int. Cl. G06F 3/01; G06F 3/041; G06F 3/044

(52) U.S. Cl. CPC G06F 3/016; G06F 3/0414; G06F 3/044

(57) ABSTRACT

An assembly includes a support structure, an input panel having an input surface and including a plurality of first electrodes separated from at least one second electrode by a layer of piezoelectric material, and one or more mounting structures mechanically coupling the input panel to the support structure. Each mounting structure is fixed to the input panel at one or more connection regions. The one or more mounting structures are configured such that: in response to unit force applied to the input panel along a first direction perpendicular to the input surface, the maximum displacement of any connection region relative to the support structure is less than or equal to a first displacement; and in response to unit force applied to the input panel along a second, different, direction, the maximum displacement of any connection region is greater than or equal to a second displacement which is at least five times the first displacement.

### FIELD OF THE INVENTION

The present invention relates to mounting input panels configured for piezoelectric force sensing, and in particular to mounting such input panels in ways which are suitable for combining with haptic feedback.

### BACKGROUND

Human-machine-interface input panels are common interaction method for users to communicate with a wide variety of equipment. Examples include smart-phones, tablet computers, laptops, all-in-one personal computers (PCs), point-of-sale payment devices (automated tills/registers), consumer electronics, white goods (washing machines, tumble dryers), automotive applications (e.g. dashboard), control of industrial machinery, medical devices and so forth.

A full-display touchscreen panel is often an attractive solution for high-end products which may receive a wide variety of input types, for example smart-phones, tablet computers, laptops, all-in-one personal computers (PCs) and so forth. However, for fixed-use panels which do not require the capacity to receive such rich input data, a high resolution touchscreen panel may be too expensive and is usually unnecessary. Fixed-use panels may find applications in, for example, consumer electronics, white goods (e.g. washing machines), automotive applications (e.g. dashboard controls), control of industrial machinery, medical devices and so forth. For such applications, it may be more straightforward to define discrete buttons, arrays of buttons (e.g. a numeric pad), slider controls, dial controls and so forth.

Across the range spanning high-end product and fixed-use panels, input panels are being considered which employ piezoelectric force sensing to implement one or more of touch panels, touchscreens (a touch panel integrated with or laminated to a display), discrete buttons, slider controls, and so forth. Piezoelectric input panels may be configured for piezoelectric force sensing alone, or in combination with other forms of measurement such as projected capacitance.

WO 2016/102975 A2 and WO 2017/109455 A1 describe touch panels which are able to combine projected capacitance touch sensing with piezoelectric pressure sensing in a single touch panel. WO 2019/145674 A1 describes a method of processing signals from a touch panel for combined capacitive and force sensing. WO 2020/183194 A1 describes methods for adaptively switching between force only, capacitance only, and mixed force and capacitance sensing, in dependence on the inputs received by a touch panel.

### SUMMARY

According to a first aspect of the invention there is provided an assembly including a support structure. The assembly also includes an input panel having an input surface and including a plurality of first electrodes separated from at least one second electrode by a layer of piezoelectric material. The assembly also includes one or more mounting structures mechanically coupling the input panel to the support structure. Each mounting structure is fixed to the input panel at one or more connection regions. The one or more mounting structures are configured such that: in response to unit force applied to the input panel along a first direction perpendicular to the input surface, the maximum displacement of any connection region relative to the support structure is less than or equal to a first displacement; and in response to unit force applied to the input panel along a second, different, direction, the maximum displacement of any connection region relative to the support structure is greater than or equal to a second displacement which is at least five times the first displacement.

The input panel may be planar. The input panel may be usable as a projected capacitance touch panel. The input panel may be configured for piezoelectric force sensing and projected capacitance sensing.

The first and second directions may be defined with reference to the input panel in the absence of a force being applied by the user. In other words, in the absence of forces beyond those applied by the mounting structures and the weight of the input panel.

The first displacement may be in the first direction. The second displacement may be in the second direction. The second displacement may be at least ten times the first displacement. The second displacement may be at least fifteen times the first displacement.

A connection region may correspond to a region within which a mounting structure is fixed to the input panel. A connection region may correspond to a region within which a mounting structure is bonded to the input panel. Bonding may take the form of an adhesive, a bond formed by heat and pressure applied to the connection region, or any other suitable approach for joining two parts across an extended area. Bonding may take the form of a weld.

A connection region may correspond to a region at and around a point at which a mounting structure is fixed to the input panel. The fixing may be provided by a nut, a screw, a rivet, a retaining feature, a weld, or any suitable approach for fixing two parts together at, or substantially at, a point.

One or more of the mounting structures may be integrally formed, at least in part, with the support structure. One or more of the mounting structures may comprise an extension of the support structure.

The assembly may also include a haptic actuator mechanically coupled to the input panel and configured to excite vibrations along the second direction.

The second direction may be perpendicular to the first direction. In other words, the second direction may lie substantially in plane relative to the sensor.

The one or more mounting structures may be further configured such that, in response to unit force applied to the input panel along a third direction, the maximum displacement of any connection region relative to the support structure is greater than or equal to a third displacement which is at least five times the first displacement. The third direction may be perpendicular to the first direction and different to the second direction.

The third displacement may be in the third direction. The third displacement may be at least ten times the first displacement. The third displacement may be at least fifteen times the first displacement. The third displacement may be equal to the second displacement.

The second direction may be anti-parallel to the first direction. In other words, the second direction may be co-axial with, and opposite to, the first direction.

The one or more mounting structures may include one or more elastomeric members configured to be compressible in the second direction. Elastomeric members may be formed of natural or synthetic rubber. Configured to be compressible in the second direction refers to the elastomeric members when installed in the assembly.

Unit force may be one Newton. The first displacement may be between 1 and 5 μm. The first displacement may be between 1 and 4 μm. The first displacement may be between 1 and 3 μm. The first displacement may be between 1 and 2 μm. The first displacement may be 1 μm. The first displacement may be less than 1 μm.

Unit force may be one Newton. The second displacement may be between 10 and 100 μm. The second displacement may be between 10 and 80 μm. The second displacement may be between 10 and 30 μm. The second displacement may be between 15 and 20 μm. The second displacement may be 15 μm. The second displacement may be greater than 15 μm. The second displacement may be greater than 30 μm.

According to a second aspect of the invention, there is provided an assembly including a support structure. The assembly also includes an input panel having an input surface and comprising a plurality of first electrodes separated from at least one second electrode by a layer of piezoelectric material. The assembly also includes one or more mounting structures mechanically coupling the input panel to the support structure. Each mounting structure is fixed to the input panel at one or more connection regions. The one or more mounting structures are configured such that: displacement of the connection regions relative to the support structure has a first compliance along a first axis perpendicular to the input surface; and displacement of the connection regions relative to the support structure has a second compliance along a second axis perpendicular to the first axis, wherein the second compliance is greater than the first compliance.

The input panel may be planar. The input panel may be usable as a projected capacitance touch panel. The input panel may be configured for piezoelectric force sensing and projected capacitance sensing.

The first and second axes may be defined with reference to the input panel in the absence of a force being applied by the user. In other words, in the absence of forces beyond those applied by the mounting structures and the weight of the input panel.

The first compliance may be denoted CI and may be defined as:

$${C}_{1} = \frac{{δ}_{1}}{{F}_{1}} \qquad ( 1 )$$

In which δ₁ is the maximum displacement of any connection regions along the first axis and F₁ is a component of force along the first axis.

The second compliance may be denoted C₂ and may be defined as:

$${C}_{2} = \frac{{δ}_{2}}{{F}_{2}} \qquad ( 2 )$$

In which δ₂ is the maximum displacement of any connection regions along the second axis and F₂ is a component of force along the second axis.

In general, the first compliance C₁ and/or the second compliance C₂ may be functions of the respective displacements, i.e. C₁(δ₁) and C₂(δ₂). The first compliance C₁ and/or the second compliance C₂ may be non-linear for larger displacement, but may be approximately linear for practical displacements of the connection regions about an equilibrium condition of the assembly at which displacements δ₁, δ₂ are zero.

The condition that the second compliance is greater than the first compliance may be evaluated at the equilibrium condition of the assembly. The condition that the second compliance is greater than the first compliance may be applicable across all combinations of displacements δ₁, δ₂ which remain elastic (in the sense of being reversible upon unloading applied forces).

The second compliance may be at least five times the first compliance, for example C₂≥5.C₁. The second compliance may be at least ten times the first compliance, for example C₂≥10.C₁. The second compliance may be at least fifteen times the first compliance, for example C₂≥15.C₁.

A connection region may correspond to a region within which a mounting structure is bonded to the input panel. Bonding may take the form of an adhesive, a bond formed by heat and pressure applied to the connection region, or any other suitable approach for joining two parts across an extended area. Bonding may take the form of a weld.

A connection region may correspond to a region at and around a point at which a mounting structure is fixed to the input panel. The fixing may be provided by a nut, a screw, a rivet, a retaining feature, a weld, or any suitable approach for fixing two parts together at, or substantially at, a point.

One or more of the mounting structures may be integrally formed, at least in part, with the support structure. One or more of the mounting structures may comprise an extension of the support structure.

The assembly may also include a haptic actuator mechanically coupled to the input panel and configured to excite vibrations along the second axis.

The first compliance may be less than or equal to 10 μm.N⁻¹. The first compliance may be less than or equal to 5 82 m.N⁻¹. The first compliance may be less than or equal to 4 μm.N⁻¹. The first compliance may be less than or equal to 3 μm.N⁻¹. The first compliance may be less than or equal to 2 μm.N⁻¹. The first compliance may be less than or equal to 1 μm.N⁻¹.

The second compliance may be greater than or equal to 10 μm.N⁻¹. The second compliance may be greater than or equal to 15 μm.N⁻¹. The second compliance may be greater than or equal to 20 μm.N⁻¹. The second compliance may be greater than or equal to 30 μm.N⁻¹. The second compliance may be greater than or equal to 80 μm.N⁻¹.

The assembly according to the second aspect may include features corresponding to any features of the assembly according to the first aspect. Definitions corresponding to the assembly according to the first aspect may be equally applicable to the assembly according to the second aspect.

According to a third aspect of the invention there is provided an assembly including a support structure. The assembly also includes an input panel having an input surface and comprising a plurality of first electrodes separated from at least one second electrode by a layer of piezoelectric material. The assembly also includes one or more mounting structures mechanically coupling the input panel to the support structure. Each mounting structure is fixed to the input panel at one or more connection regions.

The one or more mounting structures are configured such that displacement of the connection regions relative to the support structure along a first axis perpendicular to the input surface exhibits a non-linear compliance approximated by a function comprising at least one discontinuity in the function or the first derivative of the function. A non-linear compliance is approximated by a function if, for practical purposes, the values of the compliance may be modelled using that function.

The input panel may be planar. The input panel may be usable as a projected capacitance touch panel. The input panel may be configured for piezoelectric force sensing and projected capacitance sensing.

The first axis may be defined with reference to the input panel in the absence of a force being applied by the user. In other words, in the absence of forces beyond those applied by the mounting structures and the weight of the input panel.

The compliance may be denoted C and may be defined as:

$$C = \frac{δ}{F} \qquad ( 3 )$$

In which δ is the maximum displacement of any connection regions along the first axis (for example δ=x−x₀ if the first axis is the x-axis, x is the current position of a point and x₀ is the equilibrium position) and F is a component of force along the first axis. The compliance C may be a function of displacement C(δ). The displacement δ may be positive, δ>o, for the direction along the first axis and directed into the input surface. The compliance C(δ) may take the form:

$$C ( δ ) = \{ \begin{matrix}{C}_{+} & for & δ > {δ}_{0} \\ {C}_{-} & for & δ \leq {δ}_{0}\end{matrix} \qquad ( 4 )$$

In which C₊ is a positive compliance for displacements above a threshold displacement δ₀ and C₌ is a negative compliance for displacements below the threshold displacement δ₀. It should be noted that the term “negative compliance” is simply a name used to refer to the compliance in the region below and including the threshold displacement δ₀. The negative compliance C₋ will still have a positive value.

The negative compliance C₋ may be greater than or equal to the positive compliance C₊, i.e. C₋>C₊. The negative compliance C₋ may be at least five times the positive compliance C₊, i.e. C₋≥5.C₊. The negative compliance C₋ may be at least ten times the positive compliance C₊, i.e. C₋≥10.C₊. The negative compliance C₋ may be at least fifteen times the positive compliance C₊, i.e. C₋≥15.C₊.

The positive compliance C₊ may be less than or equal to 10 μm.N⁻¹. The positive compliance C₊ may be less than or equal to 5 μm.N⁻¹. The positive compliance C₊ may be less than or equal to 4 μm.N⁻¹. The positive compliance C₊ may be less than or equal to 3 μm.N⁻¹. The positive compliance C₊ may be less than or equal to 2 μm.N⁻¹. The positive compliance C₊ may be less than or equal to 1 μm.N⁻¹.

The negative compliance C₋ may be greater than or equal to 10 μm.N⁻¹. The negative compliance C₋ may be greater than or equal to 15 μm.N⁻¹. The negative compliance C₋ may be greater than or equal to 20 μm.N⁻¹. The negative compliance C₋ may be greater than or equal to 30 μm.N⁻¹.

The positive compliance C₊ may be a function of displacement C₊(δ). The negative compliance C₋ may be a function of displacement C₋(δ).

A connection region may correspond to a region within which a mounting structure is bonded to the input panel. Bonding may take the form of an adhesive, a bond formed by heat and pressure applied to the connection region, or any other suitable approach for joining two parts across an extended area. Bonding may take the form of a weld.

A connection region may correspond to a region at and around a point at which a mounting structure is fixed to the input panel. The fixing may be provided by a nut, a screw, a rivet, a retaining feature, a weld, or any suitable approach for fixed two parts together at, or substantially at, a point.

One or more of the mounting structures may be integrally formed, at least in part, with the support structure. One or more of the mounting structures may comprise an extension of the support structure.

The assembly may also include a haptic actuator mechanically coupled to the input panel and configured to excite vibrations along the first axis.

The assembly according to the third aspect may include features corresponding to any features of the assemblies according to the first and/or second aspects. Definitions corresponding to the assemblies according to the first and/or second aspects may be equally applicable to the assembly according to the third aspect.

Features described hereinafter may be combinable with assemblies according to assemblies according to any of the first, second and third aspects. Definitions provided hereinafter may be applicable to assemblies according to any of the first, second and third aspects

The one or more mounting structures may be configured such that, in response to an applied force along the first direction or first axis the deformation of the input surface is concave. In other words, the one or more mounting structures should be configured such that no pair of points exists for which the respective polarisations of the piezoelectric material layer are opposite.

The one or more mounting structures may include one or more elastomeric members. Elastomeric members may be formed of natural or synthetic rubber. Configured to be compressible in the second direction refers to the elastomeric members when installed in the assembly.

The one or more mounting structures may include one or more plain bearings. Plain bearings may take the form of opposed polytetrafluoroethylene surfaces arranged to slide against one another. Additionally or alternatively, one or both surfaces for a plain bearing may formed of, or coated with, other low friction materials including, without limitation, fluoroethylenepropylene (FEP), perfluoralkoxy (PFA), tungsten disulphide, molybdenum disulphide and so forth.

The one or more mounting structures may include one or more rolling element bearings. The one or more mounting structures may include one or more ball bearings. The one or more mounting structures may include one or more roller bearings.

The one or more mounting structures may include one or more springs. The one or more mounting structures may include one or more flexures. Herein, a flexure refers to a flexible element engineered to be compliant in specific degrees of freedom.

The support structure may form part of a device. The support structure may form part of a casing of the device.

The input panel may include, or take the form of, a touch panel. The plurality of first electrodes and the at least one second electrode may be configured for sensing coordinates of a user interaction with the input surface. For example, coordinates (x, y) within a Cartesian coordinate system defined on the input surface. The input panel may include a printed circuit board. The input panel may include a flexible circuit board.

The input panel may include, or support, one or more button inputs. The plurality of first electrodes may include one or more first electrodes corresponding to respective buttons.

The plurality of first electrodes may include one or more groups of first electrodes, each such group configured to provide a slider control. A slider control may be considered to be similar to an (x, y) touchpad, except limited to a single axis.

The input panel may include, or take the form of, a touchscreen.

A device may include the assembly according to any one of the first aspect, the second aspect, or the third aspect.

The device may also include a display positioned on the opposite side of the input panel to the input surface (when the input panel is a touch panel and/or includes button and/or slider control inputs, to form a touchscreen).

The input panel may have a back surface opposed to the input surface across a thickness of the input panel. There may be a gap between the back surface and the display. The gap may be filled with air. The gap may be filled with a compliant and transparent material.

The device may be configured to use the input panel to obtain user input.

The input panel need not be planar. The input panel may be curved. The input panel may be conformal, for example, to the shape of a device (or casing thereof) incorporating that input panel. Definitions provided hereinbefore in relation to a normal of the input surface/panel may instead refer to an average surface normal to the input surface/panel. Definitions provided hereinbefore in relation to a normal of the input surface and/or input panel may instead refer to a normal to the input surface/panel local to, or at/within, each respective connection region.

### BRIEF DESCRIPTION OF THE DRAWINGS

Certain embodiments of the present invention will now be described, by way of example, with reference to the accompanying drawings in which:

FIGS. 1A and 1B are photographs showing an input panel in the form of a laptop trackpad;

FIG. 2 schematically illustrates positions on an input panel;

FIG. 3 shows inversion of piezoelectric signals between different locations on the input panel shown in FIG. 2;

FIG. 4 is a photograph showing a ledge for mounting an input panel in the form of a laptop trackpad;

FIG. 5 shows amplified piezoelectric charge raw signals from sets of five pushes at various locations across an input panel mounted with perimetric support;

FIGS. 6A to 6C schematically illustrate a first exemplary assembly;

FIG. 7 schematically illustrates a second exemplary assembly;

FIG. 8A to 8C schematically illustrate a third exemplary assembly;

FIGS. 9A and 9B schematically illustrate a fourth exemplary assembly;

FIGS. 10A and 10B schematically illustrate a fifth exemplary assembly;

FIGS. 11A and 11B schematically illustrate a sixth exemplary assembly; and

FIGS. 12A to 12G schematically illustrate a seventh exemplary assembly.

### DETAILED DESCRIPTION

In the following description, like parts are denoted by like reference numerals. Input panels which conduct force sensing need to accommodate the strain resulting from an applied force in the force sensing components.

For example, a device may use force sensors such as strain gauges or discrete piezoelectric sensors to mount an input panel to that device (or a support structure forming part of that device). Such mountings effectively use the strain gauges or discrete piezoelectric sensors as ‘springs’, and rely on the input panel being substantially stiffer than the strain gauges or discrete piezoelectric sensors providing the ‘springs’. Using such an approach, movement of the input panel for haptic feedback is possible.

The information available from point measurements of force only at corners and/or other points around the perimeter of an input panel is limited. Piezoelectric enabled input panels such as those described in WO 2016/102975 A2, WO 2017/109455 A1, WO 2019/145674 A1 and WO 2020/183194 A1 work differently and require different mechanical boundary conditions from the mounting. In particular, the input panel needs to be firmly supported so that the input panel deforms (similar to plate bending) in preference to the mounting, in order to maximise the resulting piezoelectric signals for detection. However, such firm mechanical mounting makes integration of haptic feedback using vibrations difficult or impossible. For small, handheld devices, the unit device may be shaken by a rotating or resonating mass, which is felt by a user holding the unit. In contrast, for a larger system which is not carried, (e.g. a laptop) it is not practical or desirable to shake the entire device, and it would be better to excite haptic vibrations of the input panel independently from the rest of the device.

This requires new types of mounting structures for input panels.

### Mounting Requirements for Piezoelectric Force-Sensing

Input panels implementing piezoelectric force sensing require a firm, uniform and regular mounting about the input panel perimeter. In particular, it is preferable that there are no inflexion loci through which, in response to a press by a user, the polarisation of a layer of piezoelectric material in the input panel would reverse polarity. A good solution to ensure this is to use a perimetric sensor support

For ‘firm’ mounting, a typical guideline is that there should be no more than 1 μm deflection in the mounting per newton N of applied force (directed into the input surface of an input panel). Acceptable performance may be obtainable if the deflection is limited to no more than 10 μm deflection in the mounting per newton N of applied force (directed into the input surface of an input panel). It is also preferable that the deflection at a point where a force is applied by a user should be greater than any deflections around the edges of the input panel.

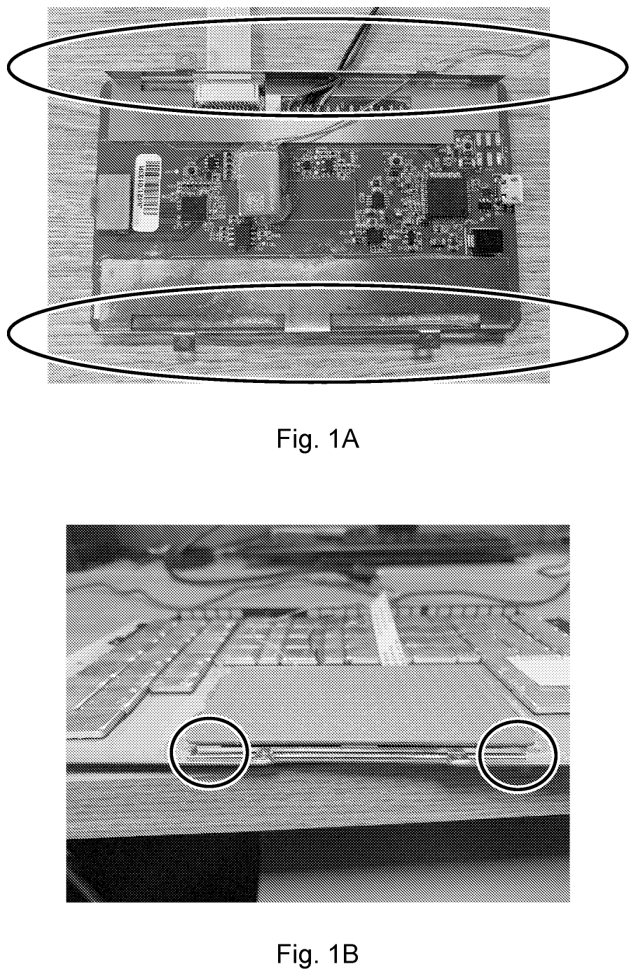

Referring to FIGS. 1A and 1B, an input panel in the form of a laptop trackpad (a type of touch panel) is shown.

The input panel shown in FIGS. 1A and 1B has sprung edge supports to allow haptic response. However, this would not be suitable for mounting an input panel for piezoelectric force sensing, because it would provide poor force sensing performance.

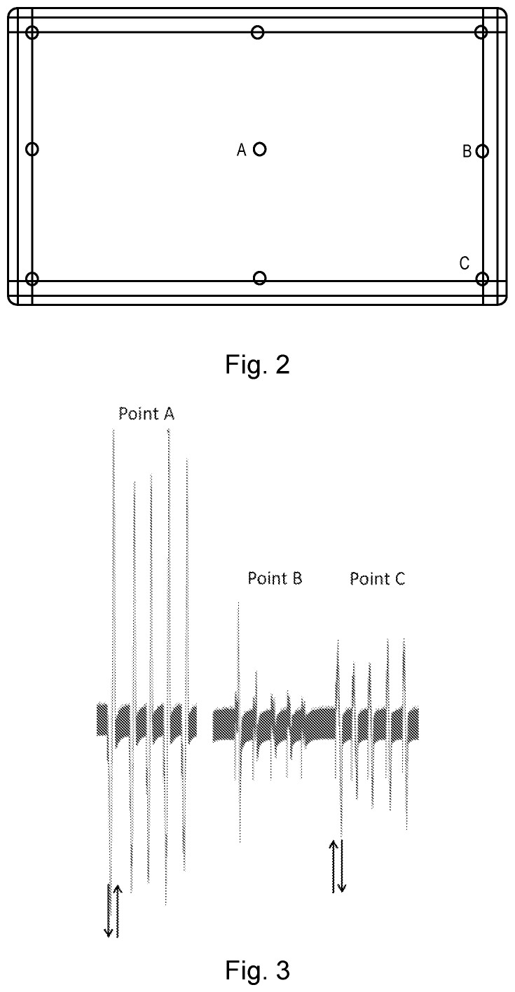

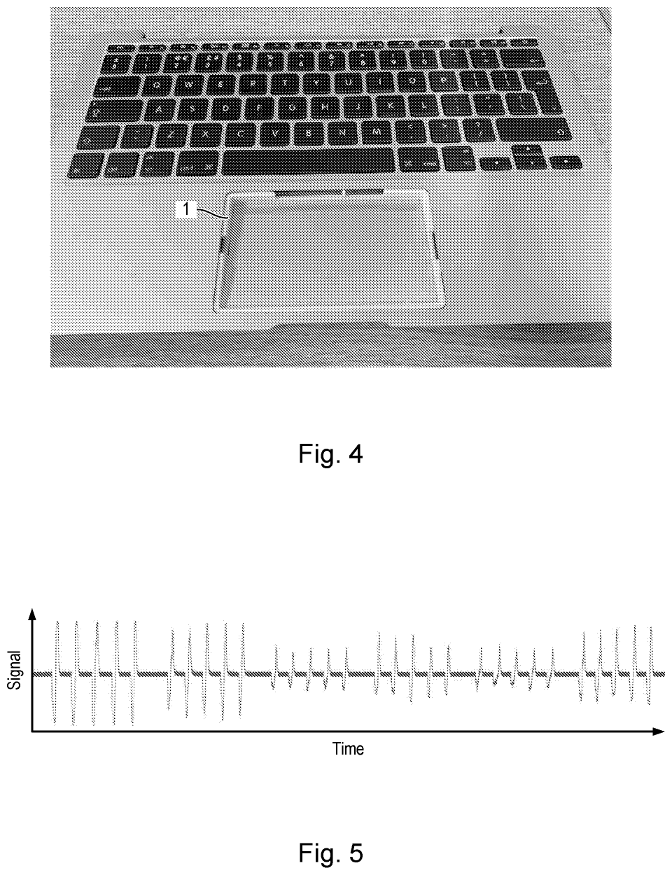

For example, referring also to FIGS. 2 and 3, inversion of piezoelectric signals is illustrated. FIG. 2 schematically illustrates an input panel, with points labelled “A”, “B” and “C”. FIG. 3 shows excerpts of amplified piezoelectric charge signals from sets of five pushes, corresponding to the points labelled “A”, “B” and “C” in FIG. 2.

It may be observed that the signal inverts between point A and points Band C. This implies a “dead area” between the points, i.e. a locus of points where a layer of piezoelectric material switches polarisation (e.g. transitions from tensile to compressive strains). It is impossible to create a uniformity correction map in such dead areas, so the force sensing of the input panel will have poor uniformity

### Mounting Requirements for Haptics Actuation

As discussed hereinbefore, suitable mounting for input panels configured for piezoelectric force sensing may be obtained by firm, uniform and regular mounting about the input panel perimeter.

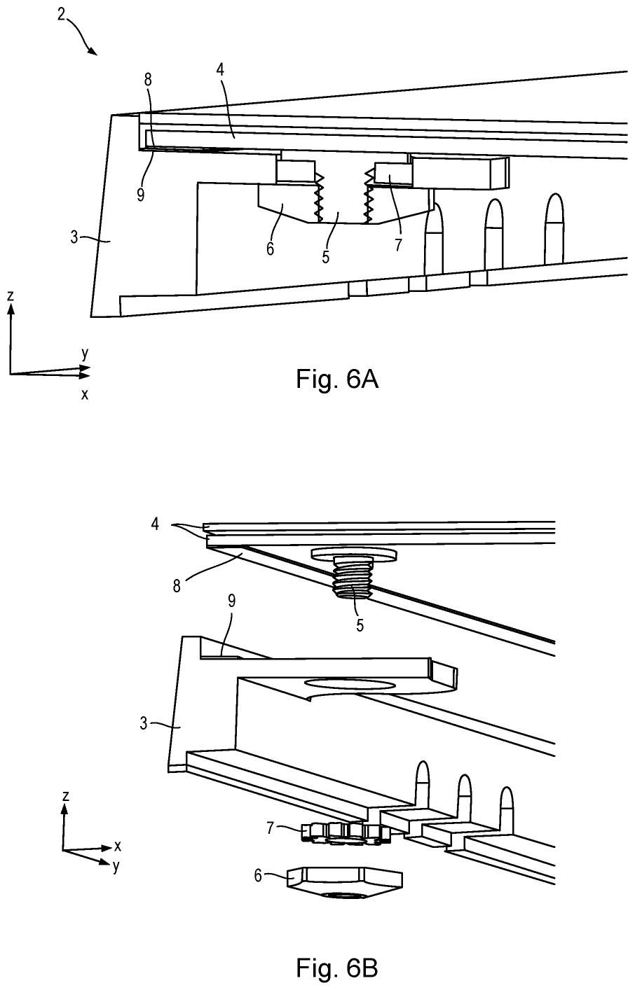

Referring also to FIG. 4, a second mounting for an input panel in the form of a laptop trackpad is shown.

The mounting shown in FIG. 4 provides perimetric sensor support, which should provide good force sensing once the input panel has been glued to a mounting structure in the form of a white ledge/shelf 1 formed in the casing of the laptop keyboard unit. However, because the input panel will be glued into the mounting, this will provide poor haptics response.

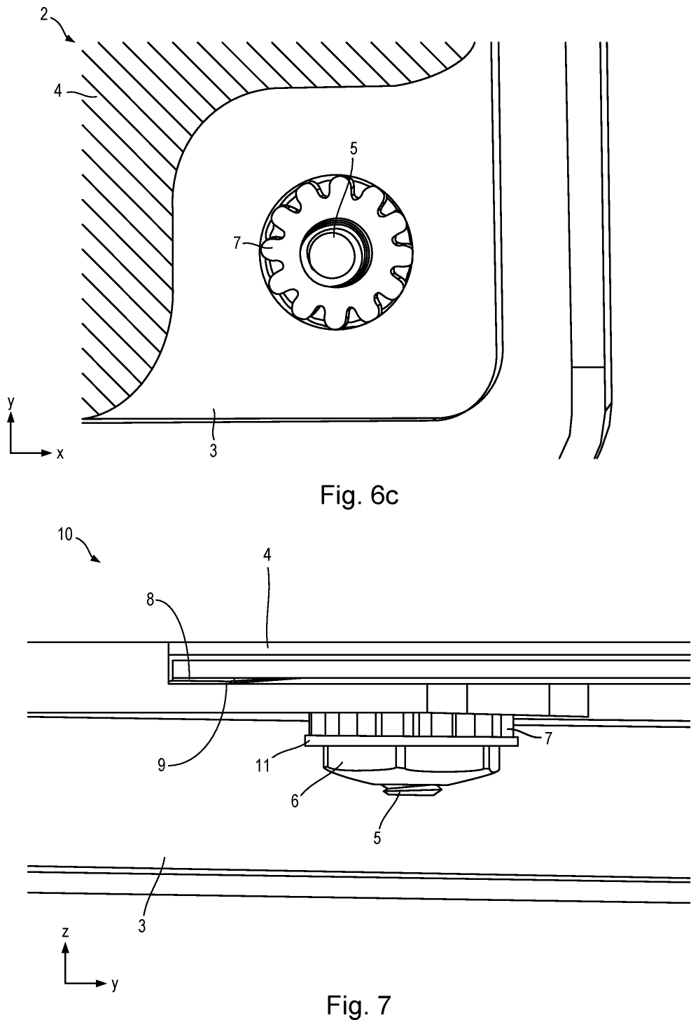

Referring also to FIG. 5, amplified piezoelectric charge raw signals are shown from sets of five pushes at various locations across an input panel mounted with perimetric support comparable to that shown in FIG. 4.

It may be observed that the piezoelectric signal response is similar across the sensor—there is no inversion. Consequently, any local variations in piezoelectric signal response sensitivity can be calibrated with a uniformity correction map.

In order to provide good haptic feedback to a user's finger, an example of suitable parameters would be a physical displacement in the sensor of at least 30 μm at a frequency around 100 to 200 Hz. A typical haptic actuator is capable of producing 3Gs acceleration on a 60 g load, which equates to approximately 1.7 N force on a moderately sized input panel (for example for a laptop trackpad).

Mounting in the form of perimetric sensor support holds the input panel too firmly to allow a good haptics response.

### Mountings for Combined Piezoelectric Force Sensing and Haptics

Hereinafter, examples of assemblies are described which control the overall compliance of one or more mounting structures to provide the firm and uniform support needed for piezoelectric measurements in a first direction, whilst leaving sufficient compliance in a second, different direction, to permit haptic excitation to be provided to the input panel.

A mounting for an input panel incorporating piezo-film based force sensing should obey some constraints to be also compatible with haptic excitations. There must be a constraint to the input panel in a direction opposing the direction in which force will be applied by a user. This constraint should be applied in a firm, uniform, and regular manner, so that there are no unresponsive areas or inflexions in the piezoelectric response, regardless of the location on the input panel where the force is applied. The preferred solution is to use a substantially perimetric support.

There should also be at least one different direction in which the sensor has freedom to move. For example, for a typical haptic actuator coupled to a laptop trackpad, by 30 μm or more when a force of about 1.7 N is applied. Depending on the orientation and type of haptics actuator used, this second direction might be in the plane of the input panel, or it could be in a direction substantially perpendicular to the input panel, for example opposite to an expected direction for user applied forces.

The examples described hereinafter are for the purposes of explanation, and are not intended to limit the scope of the present invention as defined by the appended claims. Further, optional, features are described in the summary section hereinbefore.

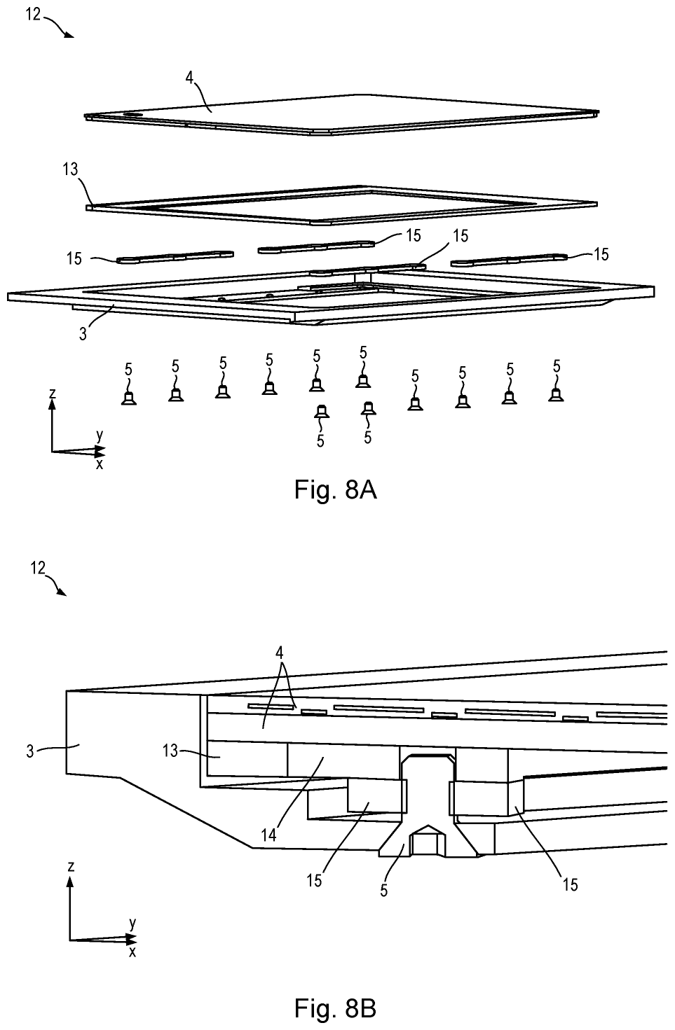

### First Exemplary Assembly Referring also to FIGS. 6A to 6C, a first exemplary assembly 2 (hereinafter “first assembly”) is shown.

The first assembly 2 includes a mounting bracket 3 which is securely attached to, or integrally formed with, a support structure (not shown) such as, for example, the body, casing or housing of a device incorporating the first assembly 2. The input panel 4 is fixed to the mounting bracket 3 using a mount screw 5 and retaining nut 6. The mount screw 5 is received through a hole in the mounting bracket 3 which has a substantially larger diameter. The mount screw 5 is held centrally within the through-hole in the mounting bracket 3 by an elastomeric element 7 received over the mount screw and contained within the through-hole.

Preferably, a first strip of low friction material 8 such as polytetrafluoroethylene (PTFE) supported on an underside of the input panel 4 forms a plain bearing with an opposing second strip of low friction material 9, so as to reduce friction for movements in lateral directions (perpendicular to the normal of an upper, input surface of the input panel). Other low friction materials may be used instead of, or in addition to, PTFE. For example, fluoroethylenepropylene (FEP), perfluoralkoxy (PFA), tungsten disulphide, molybdenum disulphide, and so forth.

Forces applied by a user to the input surface (upper as illustrated) of the input panel 4 will act along a first direction (negative z-direction as illustrated), parallel to the axis of the mount screw 5.

The elastomeric element 7 is profiled (e.g. flower-shaped as shown) to allow movement in the lateral plane (x-y as illustrated) due to deformation of the elastomer under force applied by a haptic unit (not shown) coupled to the input panel 4. The Shore hardness of the elastomeric element 7 should be optimised to allow sufficient movement for haptics excitation. For example, approximately 40A Shore hardness. The specific profile (shape) of the elastomeric element 7 shown in FIGS. 6A to 6C is indicative, and may be modified in order to enhance or restrict movement in specific directions. The elastomeric element 7 should preferably not fill the entire space between the mount screw 5 and the mounting bracket due to most elastomers having little or no volume compressibility. In the example shown in FIGS. 6A to 6C, the elastomer may be deformed into the gaps between “petals” of the flow-shaped profile, permitting deformation in lateral directions whilst maintaining essentially fixed overall volume.

The retaining nut 6, combined with the input panel 4 abutting the mounting bracket 3, prevents vertical movements in the first direction (along the illustrated z-axis).

Collectively, the mounting bracket 3, mount screw 5, retaining nut 6, elastomeric element 7, and optionally the low friction strips 8, 9, form a mounting structure mechanically coupling the input panel 4 to the support structure (not shown). The location(s) where the input panel 4 is actually fixed to this mounting structure are termed connection regions. FIGS. 6A to 6C illustrate one connection region, and multiple other connection regions are provided around the remaining perimeter of the input panel 4.

In this way, there is sufficiently firm support for piezoelectric measurements, yet haptic excitations may be excited in lateral directions by coupling a haptic actuator (not shown) to the input panel 4.

### Second Exemplary Assembly

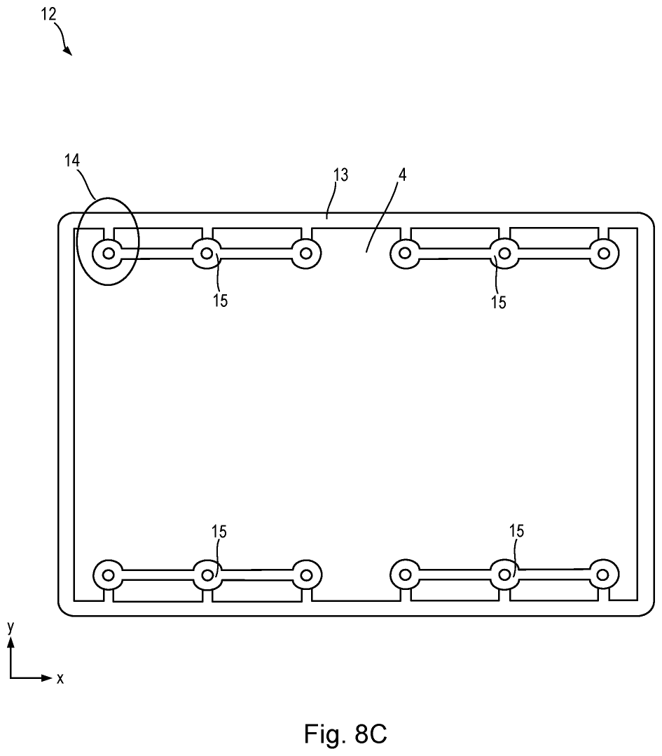

Referring also to FIG. 7, a second exemplary assembly 10 (hereinafter “second assembly”) is shown.

The second assembly 10 is similar to the first assembly 2, except that lateral movements are constrained because the through-hole in the mounting bracket 3 has a narrower diameter, only just wide enough to receive the mount screw 5. The elastomeric element 7 also has a narrower diameter through-hole and just fits over the mount screw 5. The mounting bracket 3 is securely attached to, or integrally formed with, a support structure (not shown) such as, for example, the body, casing or housing of a device incorporating the second assembly 10.

In contrast to the first assembly 2, in the second assembly 10 the elastomeric element 7 is positioned between a washer 11 and an underside (relative to an input surface of the input panel 4) of the mounting bracket 3, secured in place by the retaining nut 6.

A first axis (z-axis as illustrated) runs parallel to the axis of the mount screw 5. When a user presses down on the input surface of the input panel 4 (in a first, negative z-direction along the first axis), the input panel 4 abuts the mounting bracket 3 and the connection region is constrained from significant downward deflection by the stiffness of the mounting bracket 3 (relatively low compliance compared to the elastomeric element 7). Similarly, the close fit of the mount screw 5 within the through-hole of the mounting bracket 3 prevent significant lateral displacements (within the illustrated x-y plane perpendicular the first axis z).

However, a force acting upwards (in a second, positive z-direction along the first axis z, opposite to the first, negative z-direction) may compress the elastomeric element 7, providing a larger displacement in response to unit force. Equivalently, there is a higher compliance for upward displacements of the connection region.

In this way, a haptic actuator (not shown) arranged to excite vibrations along the first axis (z-axis as illustrated) can still excite vibrations of the input panel 4 with amplitude large enough for a user to sense.

The specific profile of the elastomeric element 7 shown in FIG. 7 is indicative, and may be modified in order to enhance or restrict movement along the first axis (z-axis as illustrated). The elastomeric element 7 of the second assembly 10 may be the same as, or different to, the elastomeric element 7 of the first assembly 2.

Collectively, the mounting bracket 3, mount screw 5, retaining nut 6, elastomeric element 7, the washer 11, and optionally the low friction strips 8, 9, form a mounting structure mechanically coupling the input panel 4 to the support structure (not shown). The location(s) where the input panel 4 is actually fixed to this mounting structure are termed connection regions. FIG. 7 illustrates one connection region, and multiple other connection regions are provided around the remaining perimeter of the input panel 4.

### Third Exemplary Assembly

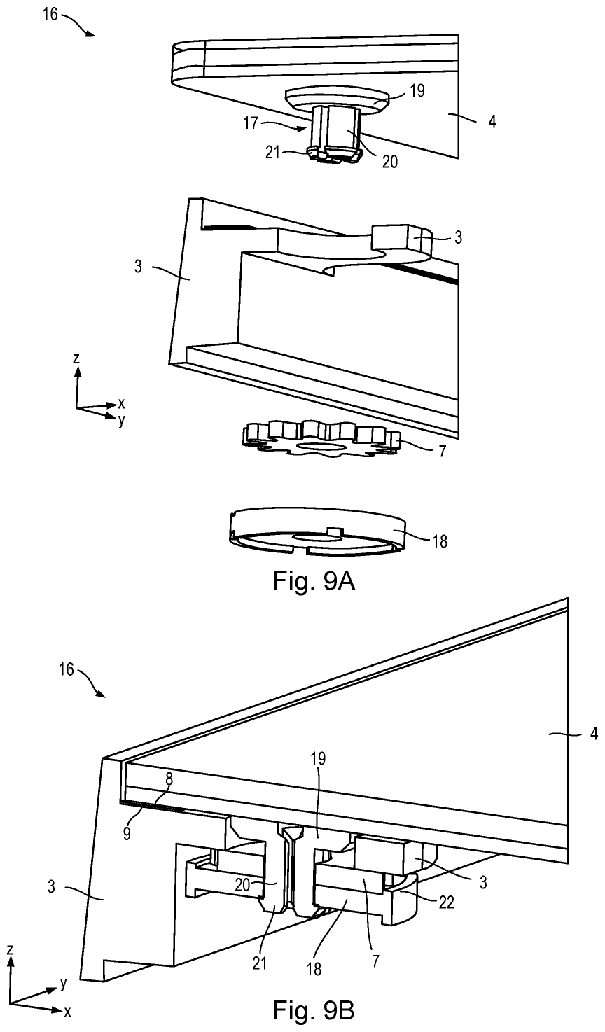

Referring also to FIGS. 8A to 8C, a third exemplary assembly 12 (hereinafter “third assembly”) is shown.

In the third assembly 12, an annular elastomeric element 13 is bonded to the input panel 4 around its perimeter (on the underside opposed to the input surface). The shape of the annular elastomeric element 13 generally conforms to the shape of the input panel 4. Flexible connectors 14 extend inward from the inner perimeter of annular elastomeric element 13, and are not bonded to the input panel 4. Fixing plates 15 are bonded to the flexible connectors 14 of the annular elastomeric element 13 so that the annular elastomeric element 13 is sandwiched between the fixing plates 15 and the input panel 4.

The fixing plates 15 are securely fixed to the mounting bracket 3 using mount screws 5 passed through holes in the mounting bracket 3 and received into threaded holes in the fixing plates 15. The mounting bracket 3 is securely attached to, or integrally formed with, a support structure (not shown) such as, for example, the body, casing or housing of a device incorporating the third assembly 12.

Low volume compressibility of the elastomeric material forming the annular elastomeric element 13 means that the input panel 4 is firmly supported in response to a user pressing down on the input surface of the input panel 4 (in a first direction perpendicular to the input surface, corresponding to the negative z-direction as illustrated). However, the flexible connectors permit lateral movements (perpendicular to the first direction, in the x-y plane as illustrated). The shape, dimensions and number of flexible connectors 14 may be modified in order to enhance or restrict movement in lateral directions.

Collectively, the mounting bracket 3, mount screws 5, annular elastomeric element 13, flexible members 14, fixing plates 15, and optionally the low friction strips 8, 9, form a mounting structure mechanically coupling the input panel 4 to the support structure (not shown). The location(s) where the input panel 4 is actually fixed to this mounting structure are termed connection regions. In the third assembly 12, there is a single connection region which extends around the perimeter of the input panel 4 and within which the input panel 4 is bonded to the annular elastomeric element 13.

### Fourth Exemplary Assembly

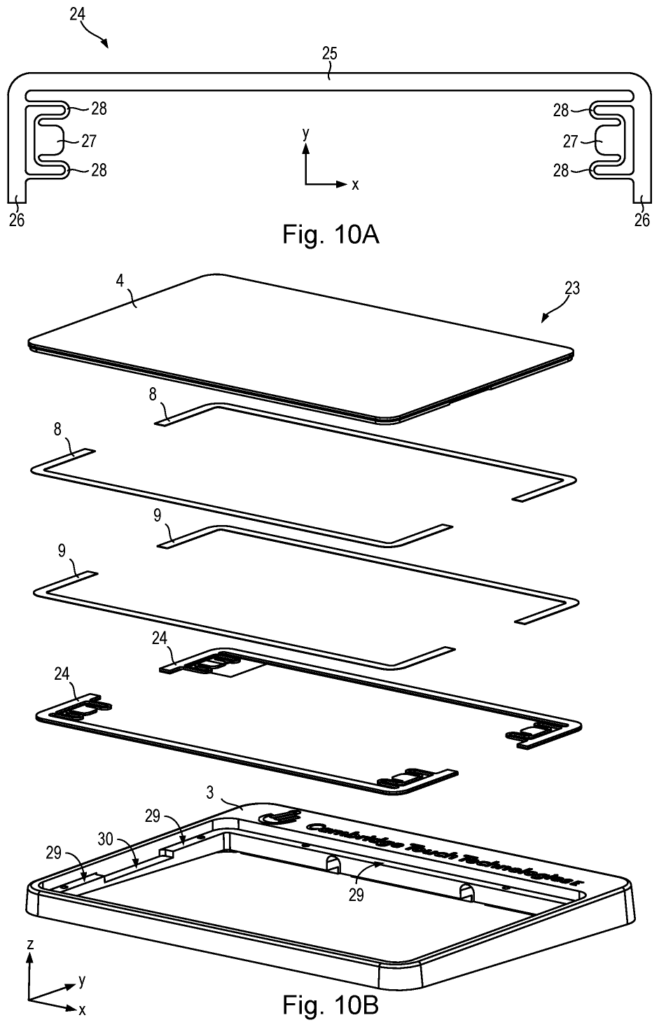

Referring also to FIGS. 9A and 9B, a fourth exemplary assembly 16 (hereinafter “fourth assembly”) is shown.

The fourth assembly 16 is the same as the second assembly 10, except that the mount screw 5 is replaced by a clip arrangement 17, and the retaining nut 6 and washer 11 are replaced by a retaining annulus 18.

The clip arrangement includes a generally circular base 19 from which a number of tines 20 extend (four are illustrated in FIGS. 9A and 9B). Each tine 20 includes a catch 21 at the opposite end to the base 19. The base 19 has a diameter just large enough to be received into the through-hole of the mounting bracket 3, such that lateral movements (in the x-y plane as illustrated) are prevented. The elastomeric element 7 is received over the tines 19 and abuts the underside of the mounting bracket 3. The retaining annulus 18 includes a through-hole which is just large enough (or even just slightly too small) to receive the tines 19 without stressing the tines 19. The catches 21 are shaped so that pressing them into the though-hole of the retaining annulus forces the tines 19 together until the catches 21 pass through and spring back, holding the retaining annulus 18 securely against the elastomeric element 7. The retaining annulus 18 may also include a lip 22 which extends around the perimeter of the retaining annulus 18 and is just large enough to receive the outer perimeter of the elastomeric element 7.

Optionally, first 8 and second 9 low friction strips may be included between the input panel 4 and the mounting bracket 3. This may be useful in examples in which an actuator is configured to generate haptic actuation by ‘flexing’ the input panel 4 into a slightly arched shape, instead of displacing the entire input panel 4 along the positive z-direction. In such examples, some of the edges/parts of the perimeter need to move slightly relative to the mounting bracket 3, and the optional inclusion of the first 8 and second 9 low friction strips will assist this.

When a user presses down on the input surface of the input panel 4 (in a first, negative z-direction along the first axis), the input panel 4 abuts the mounting bracket 3 and the connection region is constrained from significant downward deflection by the stiffness of the mounting bracket 3 (relatively low compliance compared to the elastomeric element 7). Similarly, the close fit of the base 19 of the clip arrangement 17 within the through-hole of the mounting bracket 3 prevent significant lateral displacements (within the illustrated x-y plane perpendicular the first axis z).

However, a force acting upwards (in a second, positive z-direction along the first axis z, opposite to the first, negative z-direction) may compress the elastomeric element 7, providing a larger displacement in response to unit force. Equivalently, there is a higher compliance for upward displacements of the connection region.

In this way, a haptic actuator (not shown) arranged to excite vibrations along the first axis (z-axis as illustrated) can still excite vibrations of the input panel 4 with amplitude large enough for a user to sense.

The specific profile of the elastomeric element 7 shown in FIGS. 9A and 9B is indicative, and may be modified in order to enhance or restrict movement along the first axis (z-axis as illustrated). The elastomeric element 7 of the fourth assembly 16 may be the same as, or different to, the elastomeric elements 7 of the first assembly 2 and/or the second assembly 10.

Collectively, the mounting bracket 3, clip arrangement 17, retaining annulus 18, elastomeric element 7, and optionally the low friction strips 8, 9, form a mounting structure mechanically coupling the input panel 4 to the support structure (not shown). The location(s) where the input panel 4 is actually fixed to this mounting structure are termed connection regions. FIGS. 9A and 9B illustrate one connection region, and multiple other connection regions are provided around the remaining perimeter of the input panel 4.

### Fifth Exemplary Assembly

The first to fourth assembles 2, 10, 12, 16 have included elastomeric elements 7, 13 to provide relatively higher compliance directions for haptics response. However, use of elastomeric elements is not essential, and in other examples springs or flexures may be used.

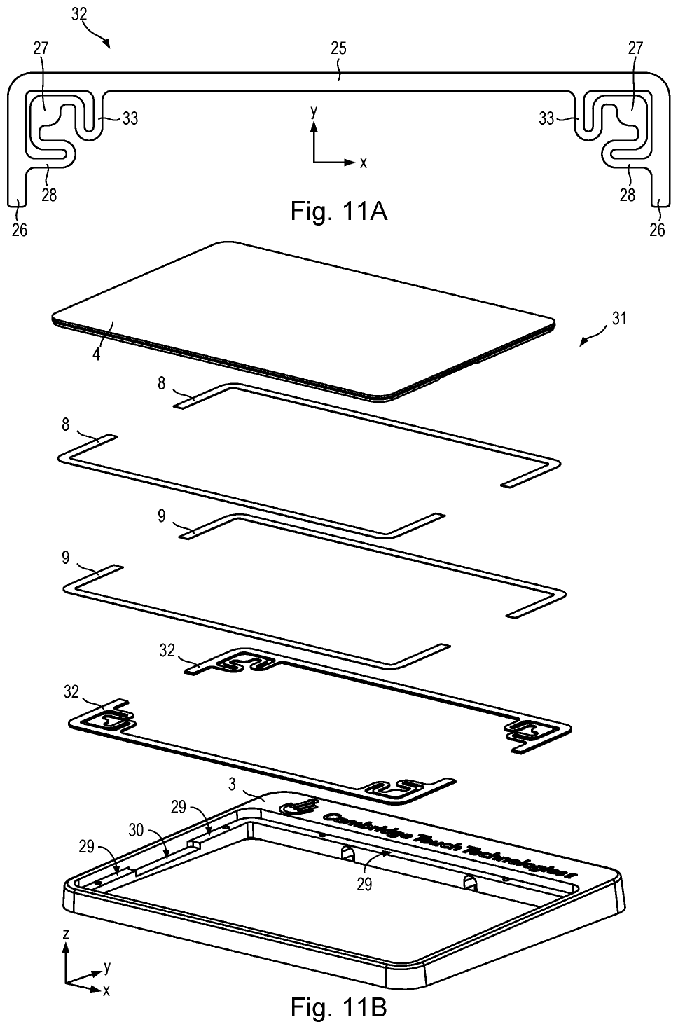

For example, referring also to FIGS. 10A and 10B, a fifth exemplary assembly 23 (hereinafter “fifth assembly”) is shown, which includes a first spring element 24. FIG. 10A shows a schematic plan view of the first spring element 24. FIG. 10B is a schematic exploded view of the fifth exemplary assembly 23.

The first spring element 24 includes a long edge 25 extending parallel to the illustrated x-axis, connected at either end to short edges 26 extending parallel to the illustrated y-axis. The short edges 26 need not be perpendicular to the long edge 25, but are preferably substantially parallel to one another. A connection pad 27 is connected to each of the short edges 26 by a pair of first flexures 28 positioned on either side (parallel to the illustrated y-axis) of the connection pad 27. Each first flexure 28 is configured for deflection along the illustrated y-direction. In this way, each connection pad 27 may be displaced relative to the connected short edge 26 parallel to the y-axis, whilst being substantially restrained from relative displacement parallel to the x-axis. The first flexures 28 also permit deflection out of the x-y plane, but such movements may be constrained in either or both directions in the fifth assembly 23, as explained hereinafter. The first spring element 24 is preferably formed of metal, for example steel, and may be formed using a subtractive process such as etching or stamping.

Referring in particular to FIG. 10B, assembly and operation of the fifth assembly 23 shall be explained in further detail.

First low friction strips 8 are bonded to the underside of the input panel 4. In the example shown in FIG. 10B, a pair of low friction strips 8 are used, each of which includes a long edge and a pair of short edges having substantially the same shape and area as the long 25 and short 26 edges of the first spring element 24.

Second low friction strips 9 are bonded to first spring elements 24, and the connection pads 27 of the first spring elements 24 are bonded (or otherwise secured) to the underside of the input panel 4. The parts of the input panel 4 connected to the connection pads 27 provide the connection regions. In this way, the low friction strips 8, 9 contact one another to form plain bearings, and the edges 25, 26 of the first spring elements 24 are able to move relative to the input panel 4 by deflection of the first flexures 28. In the example of the fifth assembly 23 shown in FIG. 10B, a pair of first spring elements 24 is used, each having the long edge 25 aligned parallel to the illustrated x-axis, and the first spring elements 24 reflected about a plane parallel to the illustrated x-axis. The precise arrangement is not critical provided that the degrees of freedom for all of the first flexures 28 are aligned for substantially parallel deflection.

The edges 25, 26 of the first spring elements 24 are bonded (or otherwise secured) to a mounting bracket 3. In the example shown in FIG. 10B, the edges 25, 26 are bonded to a shelf 29 formed in the mounting bracket 3 and extending substantially around the perimeter of the input panel 4, with the exception of a small recess 30 used for routing a flexible connector off the input panel 4 when assembled. In other examples, connections to the input panel 4 may be made or routed differently and the recess 30 may be omitted. The mounting bracket 3 is securely attached to, or integrally formed with, a support structure (not shown) such as, for example, the body, casing or housing of a device incorporating the fifth assembly 23.

When a user presses down on the input surface of the input panel 4 (in a first, negative z-direction along the first axis), the edges of the input panel 4 are pressed down against the edges 25, 26 of the first spring elements 24, which are in turn securely supported by the shelf 29 of the mounting bracket 3, so that the connection regions are constrained from significant downward deflection by the stiffness of the mounting bracket 3. Similarly, the shapes and orientations of the first flexures 28 prevent significant lateral displacements parallel to the illustrated x-axis.

However, a force acting with a component directed along a second direction parallel to the illustrated y-axis will cause deflection of the first flexures 28, providing a larger displacement in response to unit force. Equivalently, there is a higher compliance for displacements of the connection region parallel to the second direction (y-axis as illustrated).

The first flexures 28 will also urge the input panel 4 into contact (via strips 8, 9) with the edges 25, 26, although these will not on their own prevent upwards deflection (in the positive z-direction). Therefore, the fifth assembly 23 shown in FIG. 10B may be used for haptic excitation along either or both of the illustrated y and z axes (though only in one direction along the z-axis). When excitation along only the y-axis is desired, a lip or other structure may be included to abut the top surface of the input panel 4 around the perimeter and prevent displacements in the positive z-direction.

In this way, the input panel 4 is able to slide parallel to the second direction (y-axis) on plain bearings formed between the low friction strips 8, 9, whilst also being provided with secure perimetric support against use inputs to the panel 4. A haptic actuator (not shown) arranged to excite vibrations along the second direction (y-axis as illustrated) can excite vibrations of the input panel 4 with amplitude large enough for a user to sense.

The specific shape of the first flexures 28 shown in FIGS. 10A and 10B is indicative, and may be modified in order to enhance or restrict movement along the second direction axis (y-axis as illustrated). For example, more or fewer switchbacks may be used. Similarly, the shape of the first spring elements 24 including a long edge 25 and a pair of short edges 26 is merely exemplary, and any shape and/or number of supporting elements may be used instead—the important requirements are the degrees of freedom of the flexures 28 and that the flexures 28 are coupled between the input panel 4 and the mounting bracket 3 (or other fixed support structure).

Collectively, the mounting bracket 3, first spring elements 24 (including the edges 25, 26, flexures 28 and connection pads 27), and optionally the low friction strips 8, 9, form a mounting structure mechanically coupling the input panel 4 to the support structure (not shown). The location(s) where the input panel 4 is actually fixed to this mounting structure are termed connection regions. FIGS. 10A and 10B illustrate four connection regions, each corresponding to a connection pad 27. In other examples more or fewer connection pads 27 may be used, each forming a corresponding connection region (though the first flexures 28 of each must all be arranged to deflect along a substantially parallel direction).

### Sixth Exemplary Assembly

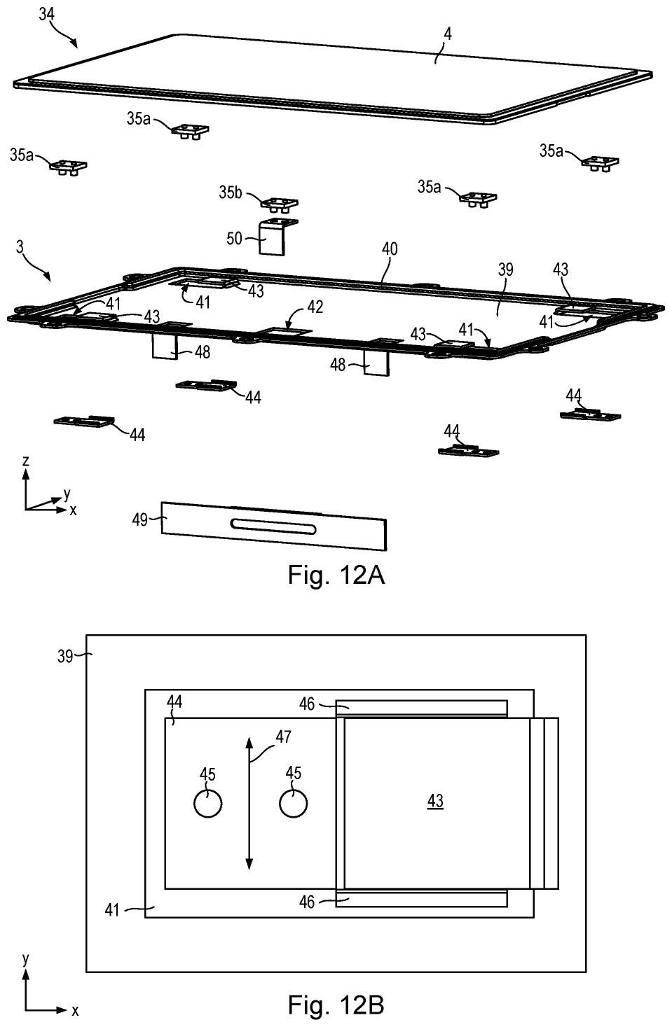

Referring also to FIGS. 11A and 11B, a sixth exemplary assembly 31 (hereinafter “sixth assembly”) is shown, which includes a second spring element 32. FIG. 11A shows a schematic plan view of the second spring element 32. FIG. 11B is a schematic exploded view of the sixth exemplary assembly 31.

The structure and assembly of the sixth assembly 31 are the same as the fifth assembly 23, except that the first spring elements 24 are replaced with the second spring elements 32.

Each second spring element 32 includes a long edge 25 and a pair of short edges 26 shaped and arranged the same as the first spring element 24. However, in the second spring element 32, each connection pad 27 is connected to the corresponding short edge 26 by a first flexure 28 arranged to permit deflection parallel to the length of the short edge 26 (y-axis as illustrated) and also connected to the long edge 25 by a second flexure 33 arranged to permit deflection parallel to the length of the long edge 25 (x-axis as illustrated). The second flexures 33 may be essentially the same as the first flexures 28 except rotated by 90°, but this is not required provided that the compliance of the second flexure 33 is configured to permit deflection parallel to the length of the long edge 25. Both first 28 and second 33 flexures permit deflection parallel to the illustrated z-axis, i.e. out of the plane containing the edges 25, 26. The second spring element 32 is preferably formed of metal, for example steel, and may be formed using a subtractive process such as etching or stamping.

When a user presses down on the input surface of the input panel 4 (in a first, negative z-direction along the first axis), the edges of the input panel 4 are pressed down against the edges 25, 26 of the first spring elements 24, which are in turn securely supported by the shelf 29 of the mounting bracket 3, so that the connection regions are constrained from significant downward deflection by the stiffness of the mounting bracket 3. Similarly, the shapes and perpendicular orientation of the first 28 and second 33 flexures connecting each connection pad 27 prevent significant lateral displacements perpendicular to the first direction (in the illustrated x-y plane).

However, a force acting with a component directed along a second direction, opposite to the first direction (positive z-direction as illustrated) deflection of the flexures 28, 33 along that direction, providing a larger displacement in response to unit force. Equivalently, there is a higher compliance for displacements of the connection region parallel to the second direction (positive z-direction as illustrated).

In this way, a haptic actuator (not shown) arranged to excite vibrations along the first axis (z-axis as illustrated) can still excite vibrations of the input panel 4 with amplitude large enough for a user to sense.

The specific shapes of the first 28 and second 33 flexures shown in FIGS. 11A and 11B are indicative, and may be modified in order to enhance or restrict movement along the second direction axis (positive z-direction as illustrated). For example, more or fewer switchbacks may be used. Similarly, the shape of the first spring elements 24 including a long edge 25 and a pair of short edges 26 is merely exemplary, and any shape and/or number of supporting elements may be used instead-the important requirements are the degrees of freedom of the flexures 28, 33 and that the flexures 28, 33 are coupled between the input panel 4 and the mounting bracket 3 (or other fixed support structure).

Collectively, the mounting bracket 3, second spring elements 32 (including the edges 25, 26, flexures 28, 33 and connection pads 27), and optionally the low friction strips 8, 9, form a mounting structure mechanically coupling the input panel 4 to the support structure (not shown). The location(s) where the input panel 4 is actually fixed to this mounting structure are termed connection regions. FIGS. 11A and 11B illustrate four connection regions, each corresponding to a connection pad 27. In other examples more or fewer connection pads 27 may be used, each forming a corresponding connection region.

### Seventh Exemplary Assembly

The first to sixth assemblies 2, 10, 12,16, 23, 31 each include either elastomeric elements 7, 13 or spring elements 24, 32 to guide and/or constrain movements. However, mounting structures suitable for both piezoelectric force input and haptic excitation may be produced using carefully arranged plain bearing elements to guide and/or constrain movements. In such mounting structures, springs or similar (not shown) may preferably be included to urge the input panel 4 to an equilibrium position along a path defined by the bearings.

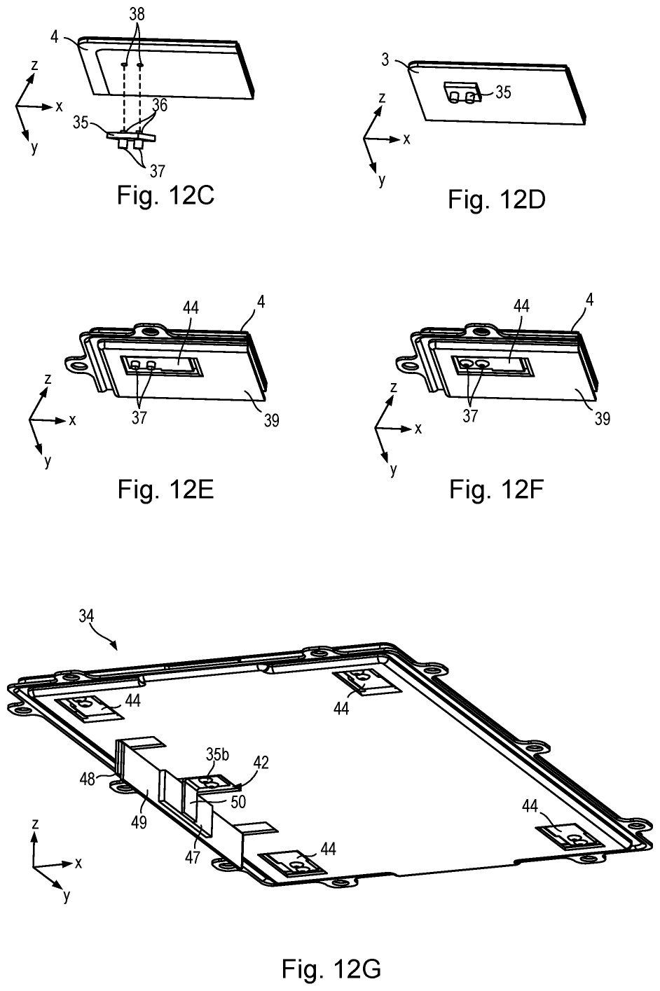

Referring also to FIGS. 12A to 12G, a seventh exemplary assembly 34 (hereinafter “seventh assembly”) is shown. FIGS. 12A is a schematic exploded view of the seventh assembly 34, FIG. 12B shows a schematic plan view of a section of the seventh assembly 34, FIGS. 12C to 12F schematically illustrate assembly of the seventh assembly 34, and FIG. 12G is a schematic projection of the underside of the seventh exemplary assembly 34 with a haptic actuator installed.

Interface parts 35 are bonded (or otherwise secured) to the underside of the input panel 4. Referring in particular to FIGS. 12C and 12D, in this example each interface part 35 is plate-like with a pair of first cylindrical protrusions 36 extending from one face, and a pair of second cylindrical protrusions 37 extending from the opposite face. The first cylindrical protrusions 36 are received into corresponding holes 38 formed into the underside of the input panel 4 (for example a PCB forming a back layer thereof). The holes 38 may provide either or both of improved positional registration and additional mechanical support. In other examples, the first cylindrical protrusions 36 and holes 38 could be omitted and the interface parts 35 could instead be simply bonded to the input panel 4.

Four interface parts 35a are connected at the corners of the input panel 4 and are used for the mounting structure, whilst a fifth interface part 35b is connected midway along a long edge of the input panel 4 and is used for coupling to a haptics actuator as described hereinafter.

A mounting bracket 3 has the same shape as the input panel 4, and includes recessed, plate-like base 39 and a raised rim 40. Apertures 41, 42 are formed in the base 39 at positions corresponding to the interface parts 35a, 35b. Four corner apertures 41 correspond to the locations of the interface parts 35a connected at corners of the input panel 4. A further aperture 42 corresponds to the position of the fifth interface part 35b. Each of the corner apertures 41 includes is partially open and partially covered by a corresponding tongue 43 which is slightly offset above and parallel to the base 39. The tongues 43 are preferably formed integrally with the base 39. The height of the tongues 43 above the base 39 is slightly less than the height of the raised rim 40 (so as to avoid interference with bending of the input panel 4).

The mounting bracket 3 may be made of metal, for example steel, or materials with comparable stiffness. When the mounting bracket 3 is formed of metal, the shape of the base 39 and rim 40, together with the apertures 41, 42 and tongues 43, may be formed by applying one or more stamping processes to sheet metal stock. Alternatively, the mounting bracket 3 may be sintered or injection moulded, depending on the materials used.

The mounting bracket 3 is securely attached to, or integrally formed with, a support structure (not shown) such as, for example, the body, casing or housing of a device incorporating the seventh assembly 34.

Referring in particular to FIG. 12E, the input panel 4 is positioned so that the rim 40 supports the perimeter of the input panel 4, and with each of the interface parts 35a, 35b aligned with the respective aperture 41, 42. The corner interface parts 35a are aligned with the portions of the corner apertures 41 which do not correspond to the tongues 43. Retaining plates 44 are then coupled to each of the corner interface parts 35a.

Referring in particular to FIGS. 12B and 12E, each retaining plate 44 includes a pair of through-holes 45 which receive the second cylindrical protrusions 37 which depend downwards from the corresponding interface part 35A. The retaining plate 44 and the interface part are securely connected, for example by adhesive/bonding. Referring in particular to FIG. 12F, in the illustrated example the interface parts 35a, 35b are formed of thermoplastic material, and heat and pressure are applied to deform the ends of the second cylindrical protrusions 37 to secure the retaining plate 44. Referring again in particular to FIG. 12B, the end of each retaining plate 44 which overlaps with the corresponding tongue 43 extends to either side of the tongue (parallel to the illustrated y-axis), with the sides bent upwards (to the positive z-direction as shown) to form lips 46 providing a channel which receives the tongue 43. The separation of the lips 46 parallel to the illustrated y-axis is just slightly larger than the width of the tongue 43 along the same direction.

In this way, retaining parts 45, and the input panel 4 coupled to them via the interface parts 35a, may move relative to the mounting bracket 3 in a direction parallel to the illustrated y-axis, along the direction 47 shown in FIG. 12B

When a user presses down on the input surface of the input panel 4 (in a first, negative z-direction along the first axis), the edges of the input panel 4 are pressed down against the lip 40 of the mounting bracket 3, providing secure perimetric support for piezoelectric measurements. The interface parts 35a and connected retaining plates 44 do not interfere with deformation of the input panel 4 because the retaining plates 44 may be deflected downwards whilst the tongues remain within the channels formed between pairs of lips 46. Similarly, the lateral movement parallel to the illustrated x-axis is constrained by the relative positions and orientations of the four corner apertures 41 and the corresponding retaining plates 44. The input panel 4 is prevented from being lifted off by the topside of retaining plates 44 abutting the undersides of corresponding tongues 43.

However, a force acting with a component directed along a second direction, oriented along the illustrated y-axis will result in a larger displacement in response to unit force, as the tongues 43 are displaced sideways within the channels formed by lips 46 of the corresponding retaining plates 44. Equivalently, there is a higher compliance for displacements of the connection region parallel to the second direction (y-direction as illustrated). At the level of the assembly overall 34, such movements take the form of the input panel 4 moving parallel to the second direction (y-axis as shown) relative to the mounting bracket 3, on a plain bearing formed between the lip 40 and the underside of the input panel 4. Optionally, low friction strips 8, 9 may be added between the lip 40 and the underside of the input panel 4 to reduce friction in the plain bearing.

In this way, a haptic actuator (not shown) arranged to excite vibrations along the second direction (y-axis as illustrated) can still excite vibrations of the input panel 4 with amplitude large enough for a user to sense.

The specific shapes of the tongues 43 and retaining plates 44 shown in FIGS. 12A to 12G are indicative, and may be modified in order to enhance or restrict movement along the second direction axis (y-direction as illustrated). For example, by adjusting the excess distance between the lips 46 compared to the width of the tongues 43.

Collectively, the mounting bracket 3, tongues 43, retaining plates 44, interface parts 35a and optionally the low friction strips 8, 9, form a mounting structure mechanically coupling the input panel 4 to the support structure (not shown). The location(s) where the input panel 4 is actually fixed to this mounting structure are termed connection regions. FIGS. 12A to 12F illustrate four connection regions, each corresponding to an interface part 35a. In other examples more or fewer interface parts 35a may be used, each forming a corresponding connection region.

### Haptic Actuator Coupling

The preceding assemblies may be used with haptic actuators such as linear or rotary mass actuators which are connected to the input panel 4 and which generate forces by accelerating the mass. Alternatively actuators may be coupled between the input panel 4 and the mounting bracket 3 (or support structure) to directly apply forces to move the panel 4.

The first to sixth assemblies 2, 10, 12,16, 23, 31 each include either elastomeric elements 7, 13 or spring elements 24, 32, and such elastomeric elements 7, 13 or spring elements 24, 32 may be arranged to bias the input panel 4 to an equilibrium position. Such examples may be used with either linear/rotary mass or direct actuators. The seventh assembly 34 may also be used with either linear/rotary mass or direct actuators. For example, additional springs/flexures (not shown) may be added to bias the input panel to an equilibrium position for stability when a linear/rotary mass actuator is used.

The seventh assembly 34 is illustrated using direct actuation provided by a strip bending piezo-actuator 47. Referring in particular to FIGS. 12A and 12G, on either side of the further aperture 42, tabs 48 are bent down by 90° from the base plate 39, and a support plate 49 is fixed between the tabs 48 (for example by bonding, welding, screws and so forth). The strip bending piezo-actuator 47 is fixed between the support plate 49 and a right-angle bracket 50. One face of the right angle bracket 50 (parallel to the y-z plane as illustrated) is fixed to the midpoint of the piezo-actuator 47, whilst the other face (parallel to the x-y plane as illustrated) includes through-holes which receive the second cylindrical protrusions 37 of the fifth interface part 35b. The fifth interface part 35b is preferably secured to the right angle bracket 50 in the same way as the corner interface parts 35a and the respective retaining plates 44, although the method is not important provided the connection is securely made. In this way, when the strip bending piezo-actuator is caused to bend, the input panel 4 is driven to move via the right angle bracket 50, and may be displaced in response due to the configuration of the mounting structure provided by the mounting bracket 3, tongues 43, retaining plates 44, interface parts 35a and optionally the low friction strips 8, 9. The strip bending piezo-actuator may also provide the restoring force needed to keep the input panel 4 in an equilibrium position when haptic vibrations are not being output (and similarly any direct actuator in other examples).

### Modifications

It will be appreciated that many modifications may be made to the embodiments hereinbefore described. Such modifications may involve equivalent and other features which are already known in the design, manufacture, mounting and use of input panels such as touch input panels, touch screens and so forth, and which may be used instead of or in addition to features already described herein. Features of one embodiment may be replaced or supplemented by features of another embodiment.

Although examples have been illustrated with reference to particular Cartesian axes x, y, z for the purposes of clear explanations of the relevant concepts, in general an assembly according to the present specification need not be configured to align with orthogonal axes.

Although examples have been described in which plain bearings are used to guide and/or constrain relative movements of the input panel 4 relative to the support structure (for example the mounting bracket 3), other types of bearings may be used instead, for example, rolling element bearings such as ball or roller (cylinder) bearings.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicant hereby gives notice that new claims may be formulated to such features and/or combinations of such features during the prosecution of the present application or of any further application derived therefrom.

1. An assembly comprising:
a support structure;
an input panel having an input surface and comprising a plurality of first electrodes separated from at least one second electrode by a layer of piezoelectric material;
one or more mounting structures mechanically coupling the input panel to the support structure, each mounting structure fixed to the input panel at one or more connection regions, wherein the one or more mounting structures are configured such that:
in response to unit force applied to the input panel along a first direction perpendicular to the input surface, the maximum displacement of any connection region relative to the support structure is less than or equal to a first displacement;
in response to unit force applied to the input panel along a second, different, direction, the maximum displacement of any connection region relative to the support structure is greater than or equal to a second displacement which is at least five times the first displacement;
wherein the one or more mounting structures comprise a mounting bracket extending around a majority of the perimeter of the input panel, wherein the mounting bracket is configured such that, in response to a force applied in the first direction, edges of the input panel are supported by the mounting bracket such that the input panel deforms in the first direction in preference to the one or more mounting structures.

2. The assembly according to claim 1, further comprising a haptic actuator mechanically coupled to the input panel and configured to excite vibrations along the second direction.

3. The assembly according to claim 1, wherein the second direction is perpendicular to the first direction.

4. The assembly according to claim 3, wherein the one or more mounting structures are further configured such that, in response to unit force applied to the input panel along a third direction, the maximum displacement of any connection region relative to the support structure is greater than or equal to a third displacement which is at least five times the first displacement;
wherein the third direction is perpendicular to the first direction and different to the second direction.

5. (canceled)

6. The assembly according to claim 1, wherein the second direction is anti-parallel to the first direction.

7. The assembly according to claim 1, wherein the one or more mounting structures comprise one or more elastomeric members configured to be compressible in the second direction.

8. The assembly according to claim 1, wherein unit force is one Newton and the first displacement is between 1 and 5 μm.

9. The assembly according to claim 1, wherein unit force is one Newton and the second displacement is between 10 and 80 μm.

10. An assembly comprising:
a support structure;
an input panel having an input surface and comprising a plurality of first electrodes separated from at least one second electrode by a layer of piezoelectric material;
one or more mounting structures mechanically coupling the input panel to the support structure, each mounting structure fixed to the input panel at one or more connection regions, wherein the one or more mounting structures are configured such that:
displacement of the connection regions relative to the support structure has a first compliance along a first axis perpendicular to the input surface; and
displacement of the connection regions relative to the support structure has a second compliance along a second axis perpendicular to the first axis, wherein the second compliance is greater than the first compliance;
wherein the one or more mounting structures comprise a mounting bracket extending around a majority of the perimeter of the input panel, wherein the mounting bracket is configured such that, in response to a force applied in the first direction, edges of the input panel are supported by the mounting bracket such that the input panel deforms in the first direction in preference to the one or more mounting structures.

11. The assembly according to claim 10, further comprising a haptic actuator mechanically coupled to the input panel and configured to excite vibrations along the second axis.

12. The assembly according to claim 10, wherein the first compliance is less than or equal to 5 μm.N⁻¹.

13. The assembly according to claim 1, wherein the second compliance is greater than or equal to 10 μm.N⁻¹.

14. An assembly comprising:
a support structure;
an input panel having an input surface and comprising a plurality of first electrodes separated from at least one second electrode by a layer of piezoelectric material;
one or more mounting structures mechanically coupling the input panel to the support structure, each mounting structure fixed to the input panel at one or more connection regions, wherein the one or more mounting structures are configured such that displacement of the connection regions relative to the support structure along a first axis perpendicular to the input surface exhibits a non-linear compliance approximated by a function comprising at least one discontinuity in the function or the first derivative of the function;
wherein the one or more mounting structures comprise a mounting bracket extending around a majority of the perimeter of the input panel, wherein the mounting bracket is configured such that, in response to a force applied in a first direction along the first axis, edges of the input panel are supported by the mounting bracket such that the input panel deforms in the first direction in preference to the one or more mounting structures.

15. The assembly according to claim 14, further comprising a haptic actuator mechanically coupled to the input panel and configured to excite vibrations along the first axis.

16. The assembly according to claim 1, wherein the one or more mounting structures are configured such that, in response to an applied force along the first direction or first axis the deformation of the input surface is concave.

17. The assembly according to claim 1, wherein the one or more mounting structures comprise at least one of:
one or more elastomeric members;
one or more plain bearings;
one or more springs; and
one or more flexures.

18. (canceled)

19. (canceled)

20. The assembly according to claim 1, wherein the support structure forms part of a device.

21. The assembly according to claim 1, wherein the input panel comprises at least one of:
a touch panel;
one or more button inputs; and
a touchscreen.

22. (canceled)

23. (canceled)

24. A device comprising the assembly according to claim 1.

25. The device according to claim 24, further comprising a display positioned on the opposite side of the input panel to the input surface.
